(19) United States
(12) Patent Application Publication
(10) Pub. No.: US 2026/0083229 A1
(43) Pub. Date: Mar. 26, 2026

(54) MULTIFUNCTIONAL COMBINATION HAIR COMB WITH THERAPEUTIC FUNCTIONS

(71) Applicant: SHENZHEN NUON MEDICAL EQUIPMENT CO., LTD., Shenzhen (CN)

(72) Inventors: Alain Dijkstra, Amstelveen (NL); LI XIANG, Shenzhen (CN); Tang Yuanzhou, Shenzhen (CN); Feng Jianxin, Shenzhen (CN)

(73) Assignee: SHENZHEN NUON MEDICAL EQUIPMENT CO., LTD., Shenzhen (CN)

(21) Appl. No.: 19/304,622

(22) Filed: Aug. 20, 2025

(30) Foreign Application Priority Data
Sep. 20, 2024 (CN) 2024113201619
Sep. 20, 2024 (CN) 2024223057770

(51) Int. Cl. A45D 24/10; A45D 24/22; A61H 11/00

(52) U.S. Cl. CPC A45D 24/10; A45D 24/22; A61H 11/00; A45D 2200/155; A45D 2200/205; A45D 2200/207; A61H 2201/02; A61H 2201/10

(57) ABSTRACT

Embodiments of the present invention disclose a multifunctional comb device comprising a first comb body and a second comb body, configured for detachable connection via a mounting groove. A swing arm, housed within the first comb body, includes a trigger portion and an action portion and is actuated by an external operating member to enable quick detachment of the second comb body. The second comb body includes a liquid storage chamber and hollow comb teeth for dispensing medicinal or cosmetic liquids directly to the scalp during combing. Additional functional modules such as phototherapy, heating, massage, and microcurrent mechanisms may be integrated within the comb structure. A card slot and buckle mechanism securely connects the two comb bodies, while still allowing for easy disassembly.

### TECHNICAL FIELD

The present invention relates to the field of personal grooming tools, and more particularly to a comb device structure. Specifically, it pertains to a multifunctional combination hair comb that facilitates the detachable integration of various comb bodies, potentially incorporating features such as phototherapy, hot and cold massage, ultrasonic wave therapy, piezoelectric therapy, magnetotherapy, microcurrent therapy, liquid dispensing, and heating functions.

### BACKGROUND

Traditional combs have long served the dual purpose of grooming and basic scalp stimulation. With evolving demands in hair and scalp care, various innovations have emerged, including combs integrated with stimulation elements, such as massage units, microcurrent emitters, or liquid dispensing modules. The prior art U.S. Ser. No. 16/996,933 and EP08875215A discloses combs having stimulation elements and detachable containers for delivering medicinal liquids or applying therapeutic treatment. However, these solutions often rely on basic latching or snap-fit mechanisms and lack an integrated architecture that offers both secure attachment and functional adaptability.

Furthermore, many existing designs feature open-sided housings or multiple perforations in the comb body to accommodate actuation mechanisms such as toggle switches, push-release buttons, or sliding locks. These structural openings are highly susceptible to the ingress of dust, dirt, and airborne pollutants, leading to hygiene concerns and demanding frequent cleaning or maintenance. Additionally, the absence of a dedicated internal cavity or mounting pathway in the primary comb body limits the ability to house detachable secondary modules in a structurally secure and contamination-resistant manner.

While stimulation elements and detachable liquid containers are known in the art, what is lacking is a system in which the first comb body includes a partially enclosed mounting groove, closed from its inner end and open only on one side, specifically engineered to receive and securely retain a second comb body equipped with functional features. The present invention addresses this gap by introducing a precisely formed mounting groove in the first comb body, combined with an internal swing arm-based locking mechanism, which not only enables reliable detachment and replacement of the second comb body but also minimizes structural openings, thus reducing contamination risk.

This configuration eliminates the need for multiple surface perforations or externally exposed attachment hardware, thereby offering a hygienic and user-friendly alternative. By enabling modular integration of therapeutic or fluid-dispensing features into a streamlined and contamination-resistant design, the invention represents a significant advancement over prior art devices, enhancing usability, cleanliness, and long-term durability.

### OBJECTS OF THE INVENTION

Some of the objects of the invention are as follows:

An object of the present invention is to provide a comb device system comprising a first comb body and a second comb body that are detachably connected, enabling modular functionality.

Another object of the present invention is to provide a comb device that integrates a swing arm and an operating member for quick and controlled separation of the second comb body from the first comb body.

Another object of the present invention is to provide a second comb body with a liquid storage chamber and hollow comb teeth for dispensing medicinal or cosmetic liquids directly to the scalp.

Another object of the present invention is to provide a comb device capable of incorporating various functional mechanisms such as phototherapy, electrotherapy, micro-current therapy, piezoelectric therapy, ultrasonic wave therapy, magnetotherapy, thermal therapy, and vibration therapy within the first or second comb body.

Another object of the present invention is to enhance functionality by incorporating one or more stimulation elements, including but not limited to a phototherapy element (Light Emitting Diodes (LEDs), or lasers elements), heating elements, cooling elements, ultrasonic wave element, vibratory elements, electrodes, etc., to support advanced therapeutic applications such as phototherapy, electrotherapy, micro-current therapy, piezoelectric therapy, ultrasonic wave therapy, magnetotherapy, thermal therapy, or vibration therapy.

Another object of the present invention is to provide a secure snap-fit, latch-hook, magnetic attachment, connection between the first and second comb bodies using a card slot and buckle design for reliable engagement and easy detachment.

Another object of the present invention is to improve hygiene, usability, and versatility by enabling easy cleaning, refilling, and replacement of the second comb body and its components.

### SUMMARY OF THE INVENTION

According to a first aspect of the present invention, a comb device is provided. The comb device comprises: a first comb body including a first shell defining a first chamber and a mounting groove formed on a convex bulge extending from the first shell, the mounting groove being configured to detachably receive a second comb body; a swing arm disposed within the first chamber and rotatably mounted to the first comb body via a hinge shaft, the swing arm comprising a trigger portion and an action portion; an operating member movably connected to the first comb body, to allow user actuation, and configured to apply force to the trigger portion of the swing arm; a push column extending from the action portion of the swing arm through a through-hole in the convex bulge, the push column being configured to engage the second comb body; and wherein, upon user actuation of the operating member, the operating member applies force to the trigger portion, causing the swing arm to rotate about the hinge shaft such that the push column advances through the through-hole and pushes against the second comb body to disengage the second comb body from the mounting groove.

In one embodiment of the invention, the operating member comprises a pressing portion configured as a button exposed on an outer surface of the first comb body.

In one embodiment of the invention, the comb device further comprising a biasing member configured to return the swing arm to its original position after actuation, wherein the biasing member comprises a first elastic member disposed between the operating member and the trigger portion of the swing arm.

In one embodiment of the invention, the biasing member comprises a second elastic member disposed between the action portion of the swing arm and an inner wall of the first chamber.

In one embodiment of the invention, the biasing member comprises a torsion spring sleeved around the hinge shaft and configured to bias the swing arm to its original position.

In one embodiment of the invention, the operating member comprises a first column configured to abut the trigger portion, a second column extending therefrom, and an annular ring for guided movement within the first comb body.

In one embodiment of the invention, the comb device further comprising a first elastic member positioned between the second column of the operating member and a third column formed on the trigger portion of the swing arm.

In one embodiment of the invention, the first chamber further houses one or more stimulation elements selected from a phototherapy element, a microcurrent module, a vibration generator, or a thermal treatment element.

In one embodiment of the invention, the second comb body comprises hollow comb teeth with pressure-sensitive micro-orifices for controlled liquid dispensing upon scalp contact during or after partial ejection.

According to a second aspect of the present invention, a comb device is provided. The comb device comprises: a first comb body comprising a mounting groove; a second comb body detachably mounted within the mounting groove of the first comb body; an operating member configured to be pressed by a user; an ejection mechanism comprising a swing arm having a push column, wherein the swing arm is configured in a manner that: upon a first press of the operating member, the push column pushes the second comb body to protrude partially from the first comb body while remaining mechanically coupled; upon a second press of the operating member, detach the second comb body from the first comb body.

In one embodiment of the invention, the swing arm is configured such that the push column passes through a through hole formed in a convex bulge of the first comb body to engage a surface of the second comb body.

In one embodiment of the invention, in the first press, the push column pushes the second comb body to disengage a buckle on an outer surface of the second comb body from a first card slot provided on an inner surface of the mounting groove and to engage the buckle with a second card slot on the inner surface of the mounting groove.

In one embodiment of the invention, the partial protrusion of the second comb body after the first press provides an intentional misalignment between the first and second comb bodies to facilitate improved mobility of a rolling element on the second comb body during use.

In one embodiment of the invention, upon a second press, the buckle disengages from the second card slot, thereby detaching the second comb body from the mounting groove of the first comb body.

In one embodiment of the invention, the second comb body includes a guide protrusion, and the mounting groove includes a corresponding guide groove, the guide protrusion being configured to align with the guide groove during insertion and detachment.

In one embodiment of the invention, the guide groove is L-shaped and configured to receive the guide protrusion via a linear insertion followed by rotational movement to lock the second comb body within the mounting groove.

In one embodiment of the invention, the partial protrusion of the second comb body in the first press is configured to allow therapeutic liquid stored within the second comb body to be more effectively dispensed through a rolling or pressure-activated outlet.

In one embodiment of the invention, the comb device further comprising a spring pin attached to the operating member, and a slot in the second comb body to lock the second comb body in the mounting groove, wherein a first press of the operating member causes the spring pin to retract and release the second comb body for partial ejection.

According to a third aspect of the invention, a method for ejecting a second comb body from a first comb body of a comb device is provided. The method comprising: providing a mounting groove in the first comb body configured to removably receive the second comb body; coupling a swing arm within the first comb body, the swing arm having a push column and being pivotable about a hinge shaft; disposing an operating member adjacent to the swing arm, the operating member being actuatable by a user; ejecting the second comb body from the mounting groove to allow its removal, in response to a press of the operating member.

In one embodiment of the invention, the method further comprising: using a torsion spring or compression spring as the elastic member to return the swing arm to its default position after each actuation of the operating member.

In the context of the specification, when an element is referred to as being “fixed to” or “disposed to” another element, it may either be directly on another element or indirectly on that other element. When a component is said to be “connected” or “connected to” another component, it may be directly connected to another component or indirectly connected to other components on the piece.

In the context of the specification, the terms “first”, “second,” and “third” are only used for descriptive purposes and do not imply the relative importance or implicitly indicate the quantity of technical features indicated.

In the context of the specification, the term “plurality” means two or more than two, unless otherwise indicated.

In the context of the specification, the term “several” means more than one, unless otherwise specified.

In the context of the specification, the term “LED” refers to one or more light-emitting diode (LED) elements that are electrically connected and configured to emit light of specific wavelengths (including visible to IR wavelengths) suitable for therapeutic purposes. The LED element or module may include drive circuitry, heat dissipation structures, and optical elements such as lenses or diffusers to control light distribution.

In the context of this specification, terms like “light,” “radiation,” “irradiation,” “emission” and “illumination,” etc. refer to electromagnetic radiation in frequency ranges varying from the visible frequencies to Infrared (IR) frequencies and wavelengths, wherein the range is inclusive of visible light, and IR frequencies and wavelengths. Preferably, it refers to low-level electromagnetic radiation of low-level red and near-infrared (NIR) light. It is to be noted here that IR radiation can be categorised into several categories according to respective wavelength ranges, which are again envisaged to be within the scope of this invention. A commonly used subdivision scheme for IR radiation includes Near IR (750-1400 nm), Short-Wavelength IR (1400-3000 nm), Mid-Wavelength IR (3000-8000 nm), Long-Wavelength IR (8000-15,000 nm), and Far IR (15,000-1,000,000 nm). In this regard, light application is at relatively low energy densities, typically below about 500 mW, as compared to other forms of laser therapy that are used for ablation, cutting, and thermally coagulating tissue. In some instances, electromagnetic radiation can also be in wavelengths in the blue or ultraviolet regions, especially for the treatment of conditions that occur at the skin surface, such as psoriasis or infection.

In the context of the specification, the term “light source” or “phototherapy source,” etc., refers to a source emitting coherent laser light, or light-emitting diodes (“LEDs”). The term “light therapy” refers to light generated from any of the sources, such as lasers, LED sources, or Super luminous diodes (“SLD”), or Organic light-emitting diodes (OLED).

In the context of the specification, the term “lamp board” refers to a printed circuit board or similar substrate on which one or more light sources are mounted and electrically connected to a power source, such as a rechargeable battery.

In the context of the specification, the term “light source” refers to any active component, such as a light-emitting diode (LED), capable of emitting phototherapy light (e.g., red, infrared, or blue) toward the scalp.

In the context of the specification, the term “light transmission hole” refers to an aperture formed in the housing of the second rotating arm, aligned with the light source to allow therapeutic light to exit the comb and reach the scalp.

In the context of the specification, the term “light transmission plate” refers to a transparent or translucent cover positioned over the light transmission hole to protect internal components while allowing light to pass through.

In the context of the specification, the term “pressing switch” refers to a mechanical actuator disposed on the surface of the comb and configured to trigger an internal switching device that activates the lamp board or associated electronics.

In the context of the specification, “Light Emitting Diodes (LEDs)” refer to semiconductor diodes capable of emitting electromagnetic radiation when supplied with an electric current. The LEDs are characterized by superior power efficiencies, smaller sizes, rapid switching speeds, physical robustness, and longer lifespans compared to incandescent or fluorescent lamps. The one or more LEDs may include through-hole type LEDs (generally emitting electromagnetic radiation in red, green, yellow, blue, and white colours), Surface Mount Technology (SMT) LEDs, Bi-colour LEDs, Pulse Width Modulated RGB (Red-Green-Blue) LEDs, and high-power LEDs, among others. The LEDs may also include UV-emitting diodes specifically selected for antimicrobial action in disinfection modules integrated into the multifunctional physiotherapy comb device.

Materials used in one or more LEDs may vary from one embodiment to another, depending upon the frequency of radiation required. Different frequencies can be obtained from LEDs made from pure or doped semiconductor materials. Commonly used semiconductor materials include nitrides of Silicon, Gallium, Aluminium, Boron, Zinc Selenide, etc., in pure form or doped with elements such as Aluminium and Indium, etc. For example, red and amber colours are produced from Aluminum Indium Gallium Phosphide (AlGaInP) based compositions, while blue, green, and cyan use Indium Gallium Nitride based compositions. White light may be produced by mixing red, green, and blue lights in equal proportions, while varying proportions may be used to generate a wider colour gamut. White and other colored lightings may also be produced using phosphor coatings such as Yttrium Aluminium Garnet (YAG) in combination with a blue LED to generate white light, and Magnesium-doped potassium fluorosilicate in combination with a blue LED to generate red light.

In addition to conventional mineral-based LEDs, one or more LEDs may also be provided on an Organic LED (OLED) based flexible panel or an inorganic LED-based flexible panel. Such OLED panels may be generated by depositing organic semiconducting materials over Thin Film Transistor (TFT) based substrates. Further, a discussion on the generation of OLED panels can be found in Bardsley, J. N (2004), “International OLED Technology Roadmap”, IEEE Journal of Selected Topics in Quantum Electronics, Vol. 10, No. 1, that is included herein in its entirety, by reference. An exemplary description of flexible inorganic light-emitting diode strips can be found in granted U.S. Pat. No. 7,476,557 B2, titled “Roll-to-roll fabricated light sheet and encapsulated semiconductor circuit devices”, which is included herein in its entirety by reference.

In the case of a stimulation element being an electrode, the stimulation element may be embodied as an open-ended conductor. The electrode may then be able to provide Transcutaneous Electrical Nerve Stimulation (TENS), Electronic Muscle Stimulation (EMS), and Microcurrent Electrical Therapy (MET) to the target surfaces. TENS therapy uses low-voltage currents to provide pain relief. Electrical impulses are delivered through electrodes placed on the surface of the body of user. The electrodes are placed at or near the comb teeth.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1 illustrates a perspective view of a multifunctional comb device, in accordance with an embodiment of the present invention.

FIG. 2 illustrates a bottom view of the comb device, in accordance with an embodiment of the present invention.

FIG. 3 illustrates a cross-sectional view of the comb device, in accordance with an embodiment of the present invention.

FIG. 4 illustrates a perspective view of a first comb body of the comb device, in accordance with an embodiment of the present invention.

FIG. 5 illustrates a perspective view of a second comb body of the comb device, in accordance with an embodiment of the present invention.

FIG. 6 illustrates a side perspective view exposing the internal components of the comb device, in accordance with an embodiment of the present invention.

FIG. 7 illustrates a top perspective view exposing internal components of the comb device, in accordance with an embodiment of the present invention.

FIG. 8 illustrates a top perspective view of the placement of a convex bulge of the comb device, in accordance with an embodiment of the present invention.

FIG. 9 illustrates a perspective view of a swing arm of the comb device, in accordance with an embodiment of the present invention.

FIG. 10 illustrates a cooperation between an operating member and a swing arm of the comb device, in accordance with an embodiment of the present invention.

FIG. 11 illustrates a cooperation between another operating member and the swing arm of the comb device, in accordance with an embodiment of the present invention.

FIGS. 12A and 12B illustrate a locking mechanism between an annular ring and a spring pin of the comb device, in accordance with an embodiment of the present invention.

FIG. 13A illustrates the comb device with a dual-interface coupling arrangement, with the second comb body is provided with a guide protrusion and the first comb body is provided with a complementary guide groove, in accordance with an embodiment of the present invention.

FIG. 13B shows a coupling arrangement where the first comb body is provided with a card slot and the second comb body is provided with a buckle, in accordance with another embodiment of the present invention.

FIGS. 14A and 14B illustrate a flow mechanism of the liquid through a micro-orifice in a closed state and an open state of the second comb body of the comb device, in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practised. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

Embodiments of the present invention disclose a multifunctional comb device capable of integrating various hair care functions, such as phototherapy, medicinal application, massage, heating, and microcurrent stimulation. The device features an innovative modular construction allowing easy detachment, operation, and maintenance of its functional components.

In an embodiment of the present invention, the comb device comprises a first comb body and a second comb body. The first comb body includes a first shell defining a first chamber, a convex bulge extending inwardly to form a mounting groove, and a swing arm rotatably mounted on a hinge shaft within the chamber. The swing arm comprises a trigger portion and an action portion, with a push column extending through a through-hole in the convex bulge to engage the second comb body. An operating member is movably connected to the first comb body and includes a pressing portion partially exposed externally, allowing user actuation. Elastic members or torsion springs are arranged to return the swing arm to its original position after actuation. The first comb body may further house a phototherapy element, battery, and circuit board, while comb teeth formed from light-transmitting material are arranged to guide therapeutic light to the scalp. The second comb body includes a second shell and hollow comb teeth, defining an internal chamber capable of storing and dispensing liquid medication.

In another embodiment, the methodology of the present invention involves operating the comb device by pressing the exposed portion of the operating member. The actuation transfers force to the trigger portion of the swing arm, causing the swing arm to rotate about the hinge shaft. The action portion of the swing arm pushes against the second comb body, disengaging it from the mounting groove for removal or replacement. Upon release of the operating member, the swing arm automatically resets via the elastic or torsion element, readying the device for reattachment of the second comb body. This user-friendly mechanism allows the second comb body to be easily removed for cleaning, liquid refilling, or function replacement, while minimizing wear, misalignment, or accidental detachment. Furthermore, light therapy and fluid dispensing functionalities operate seamlessly as part of this modular system, enhancing the effectiveness and comfort of hair care routines.

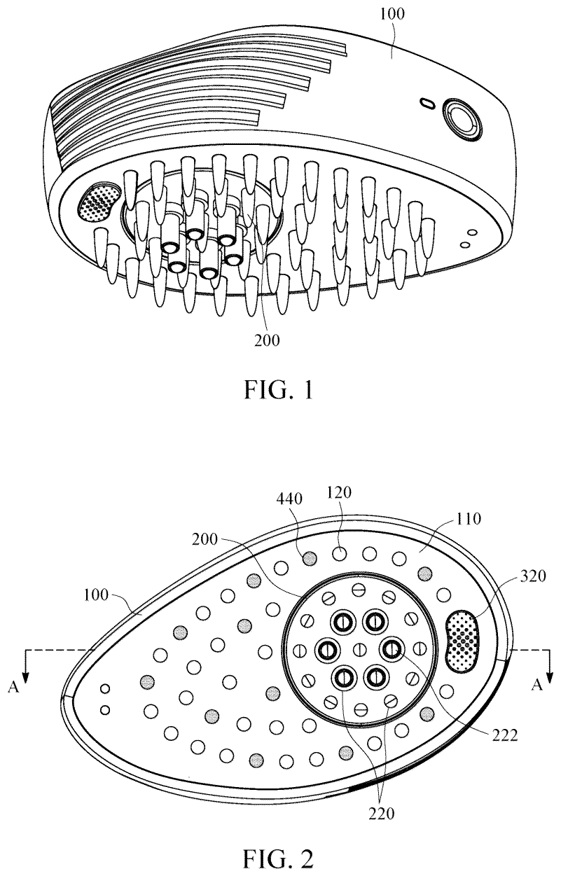

Referring to FIGS. 1 to 5, an embodiment of the present invention provides a comb device that comprises a first comb body and a second comb body. The first comb body 100 is provided with a mounting groove 170 configured to receive and secure a second comb body 200 in a detachable manner. The second comb body may incorporate one or more functionalities such as medicinal fluid dispensing, massage, phototherapy, heating, or microcurrent stimulation. Alternatively, it may be a simple comb for basic hair grooming purposes.

The second comb body 200 is designed to be removably inserted into the mounting groove 170 of the first comb body 100. This removability facilitates convenient cleaning, replenishing of medicinal liquids, or replacement during maintenance operations. To achieve controlled detachment of the second comb body, the device includes a swing arm 310, which serves as the actuating mechanism. The swing arm 310 is hinged to the first comb body 100 via a hinge shaft 360 and includes a trigger portion 316 and an action portion 312.

When an external force is applied to the trigger portion 316, the swing arm 310 rotates about the hinge shaft 360, causing the action portion 312 to engage with and apply force to the second comb body 200. This actuation results in the second comb body 200 being pushed out and disengaged from the mounting groove 170, thereby separating it from the first comb body 100.

In one embodiment, the hinge shaft 360 is positioned between the trigger portion 316 and the action portion 312. When a user applies pressure to the trigger portion 316, the swing arm 310 pivots, and the action portion 312 transmits a separating force to the second comb body 200. This force can be directed to either the end or the side of the second comb body 200. For instance, a boss structure on the side of the second comb body can serve as a contact point for the action portion 312 to exert force against, ensuring reliable ejection from the mounting groove 170.

The detachable connection between the first and second comb bodies can be achieved via a snap-fit, latch-hook, magnetic attachment, interference fit, or similar mechanical engagement. For applications requiring stronger attachment, screw fasteners or other secure locking mechanisms may be used. However, in such cases, prior disassembly of the fasteners is required before using the swing arm to eject the second comb body.

Compared to manually pulling the second comb body from the mounting groove, this swing-arm-assisted method offers improved ease of operation and reduces the risk of damaging components. Furthermore, the placement of the trigger portion (316) can be flexibly designed to accommodate different ergonomic and design requirements. The trigger may be extended to various accessible positions on the first comb body, thereby enabling more versatile and user-friendly comb configurations.

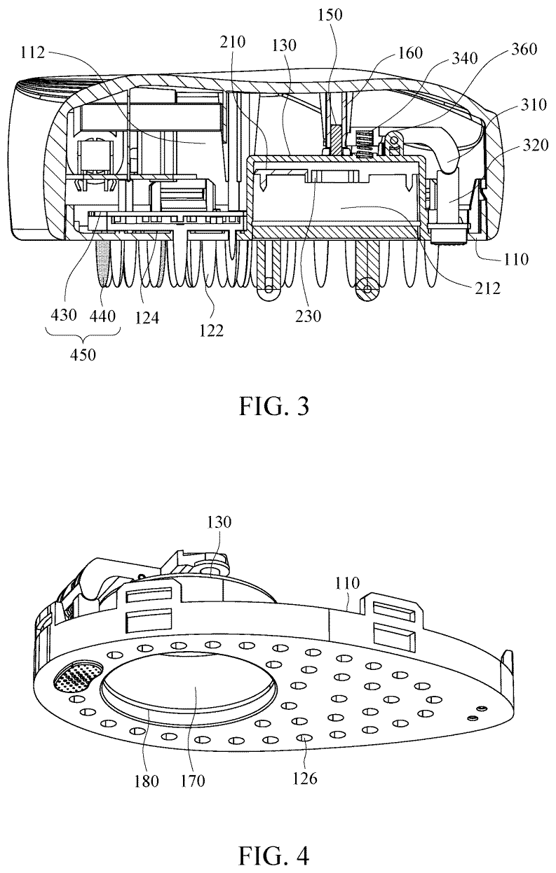

Referring to FIG. 3, in certain embodiments of the present invention, the first comb body 100 comprises a first shell 110 defining the first chamber 112. The first chamber 112 provides a dedicated space for accommodating functional components such as a heating element, phototherapy element, or other electronics. The swing arm 310 is also positioned within the first chamber 112, thereby maintaining a clean and enclosed design that prevents unintended contact from external elements and contributes to improved aesthetic integration.

To facilitate the integration of a detachable second comb body, the first shell 110 is designed with a convex bulge 130 that projects inward toward the first chamber 112. The convex bulge 130 on its external side forms a mounting groove 170 configured to receive and secure the second comb body 200. The structural design of the convex bulge 130 enhances the mechanical strength of the mounting groove 170, allowing it to bear greater loads.

To enable the controlled ejection of the second comb body 200, the convex bulge 130 is further provided with a first through hole 140 that connects the interior of the first chamber 112 to the mounting groove 170. The action portion 312 of the swing arm 310 is equipped with a push column 318, which is aligned to pass through the first through hole 140 and make contact with the rear or side surface of the second comb body 200.

When the swing arm 310 is actuated, the push column 318 travels through the first through hole 140 and exerts a force on the second comb body 200, thereby pushing it outward and disengaging it from the mounting groove 170. The configuration allows for efficient and reliable removal of the second comb body 200 without requiring excessive manual effort.

The number and positioning of the through hole(s) 140 and corresponding push column(s) 318 can be adapted based on the size and structural requirements of the second comb body 200. For example, in cases where the second comb body 200 is relatively small, a single through hole 140 and push column 318 may suffice. However, for larger comb modules, multiple through holes and push columns may be provided to distribute the applied force evenly, ensuring stable and balanced detachment from the mounting groove 170 while minimizing structural stress.

Referring to FIGS. 1 to 5, in some embodiments of the present invention, the comb device further includes an operating member 320 that is movably connected to the first comb body 100. This operating member 320 is configured such that at least a portion of it is exposed externally, allowing the user to conveniently engage with the mechanism.

The operating member 320 is positioned to abut against the trigger portion 316 of the swing arm 310. When actuated by the user, the operating member 320 applies a force to the trigger portion 316, thereby causing the swing arm 310 to rotate about a hinge shaft 360. This rotation results in the action portion 312 of the swing arm 310 moving into contact with the second comb body 200. The action portion 312 then exerts a force on the second comb body 200, causing it to disengage from the mounting groove 170 of the first comb body 100.

While it is possible to directly operate the trigger portion 316 to achieve rotation of the swing arm 310, such direct interaction may be less ergonomic or accessible. Therefore, the inclusion of the external operating member 320 enhances usability by providing a more user-friendly interface for actuating the detachment mechanism. The hinge shaft 360 is preferably positioned between the trigger portion 316 and the action portion 312 to enable efficient force transfer and mechanical leverage.

The operating member 320 may take various forms, including a push-button or lever, and may be designed to move linearly or pivotally. Importantly, while the trigger portion 316 rotates about the hinge shaft 360, the operating member 320 does not need to rotate around this axis. For instance, a linear push-button can be configured to engage the trigger portion 316 and initiate its rotation around the hinge shaft 360. This design flexibility allows for more versatile placement and aesthetically integrated configurations of the operating member 320, thereby supporting a wide range of ergonomic and structural design variations in the comb device.

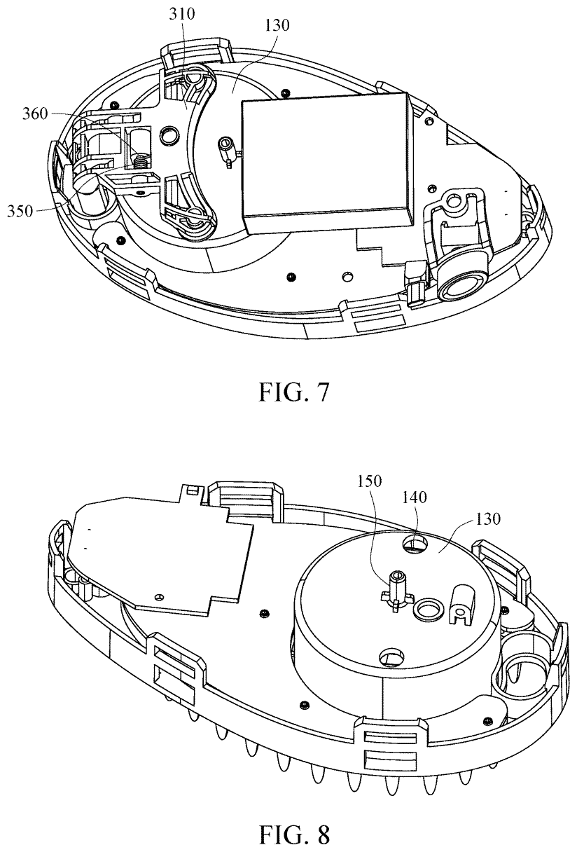

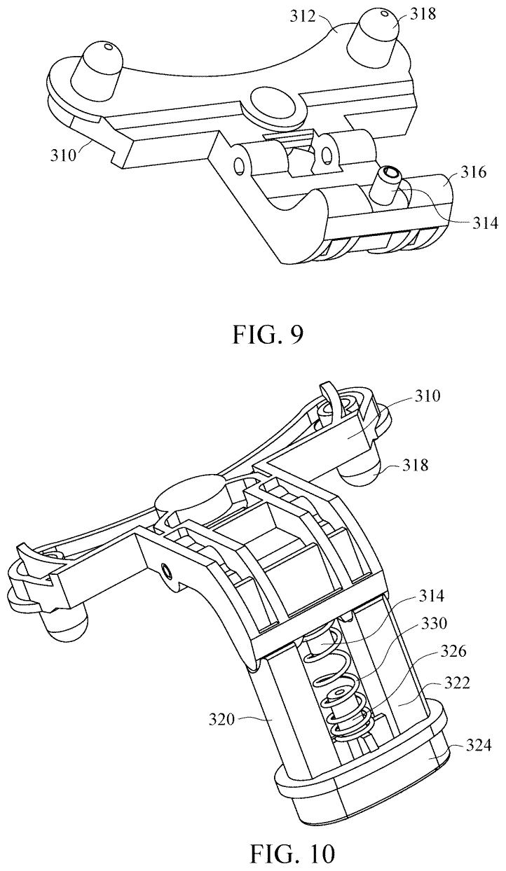

Referring to FIG. 3, FIG. 6, and FIG. 7, in some embodiments of the present invention, elastic components are incorporated to enhance the functionality and reset behavior of the swing arm mechanism. Specifically, a first elastic member 330 is disposed between the operating member 320 and the trigger portion 316, while a second elastic member 340 is positioned between the action portion 312 of the swing arm 310 and the convex bulge 130 of the first comb body 100.

In alternative embodiments, rather than using two separate elastic members, a torsion spring 350 may be installed around the hinge shaft 360. The torsion spring 350 is configured to apply a biasing force between the swing arm 310 and the first shell 110, thereby providing a return mechanism when the swing arm is displaced.

Referring to FIG. 6 and FIG. 10, in an embodiment, the second elastic member 340 functions to maintain the action portion 312 in a default position away from the second comb body 200. In its normal (uncompressed) state, the second elastic member 340 ensures that the action portion 312 does not apply any force on the second comb body 200. When the user operates the operating member 320, the swing arm 310 rotates by overcoming the resistance of the second elastic member 340. As a result, the action portion 312 advances and engages the second comb body 200, thereby pushing it out of the mounting groove 170.

Once the user releases the operating member 320, the second elastic member 340 provides a restoring force, causing the swing arm 310 to rotate back to its original position. This return motion withdraws the action portion 312 away from the second comb body 200, thereby resetting the mechanism and facilitating convenient reattachment or replacement of the comb body. Returning the action portion 312 to its original position facilitates the reinsertion of the second comb body 200 into the mounting groove 170. Beyond the reset function, the second elastic member 340 can also facilitate the return motion of the swing arm 310 toward the trigger portion 316. This helps maintain continuous contact between the trigger portion 316 and the operating member 320, ensuring responsive actuation and improving tactile feedback during user operation. The trigger portion 316 rotates about the hinge shaft 360, while the operating member 320 typically moves linearly or pivots about a different centre of rotation.

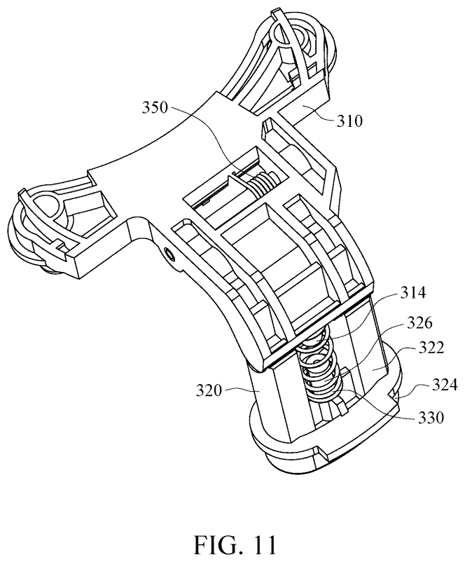

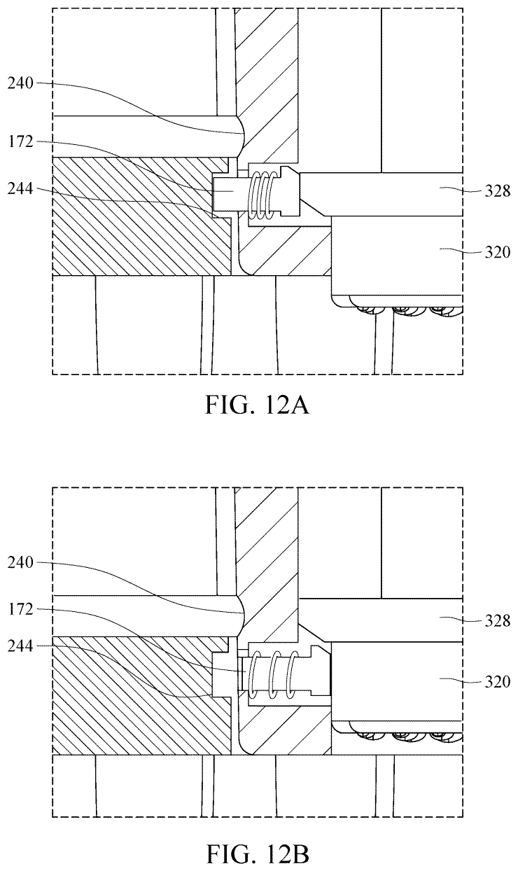

Referring to FIG. 7 and FIG. 11, in an embodiment, a torsion spring 350 may also be used in place of the second elastic member 340 to achieve this resetting function. The torsion spring 350 is sleeved around the hinge shaft 360 and is configured to simultaneously engage the swing arm 310 and the first shell 110. In its default state, the torsion spring 350 biases the swing arm 310 such that the action portion 312 remains clear of the second comb body 200, thereby preventing unintended contact or force application.

When the user activates the operating member 320, the swing arm 310 is rotated against the restoring force of the torsion spring 350, allowing the action portion 312 to engage and push the second comb body 200 outward, thereby detaching it from the mounting groove 170. Upon release of the operating member 320, the torsion spring 350 returns the swing arm 310 and the action portion 312 to their original positions, enabling easy reinsertion of the second comb body 200 into the mounting groove 170. This difference in movement trajectories leads to relative motion and friction at the point of contact between the two components, which may negatively affect the user's pressing experience and potentially hinder the proper reset action of the second elastic member.

To address this, the first elastic member 330 is introduced between the operating member 320 and the trigger portion 316. The purpose of the first elastic member is not to create separation between the parts, but to reduce contact pressure and minimize friction during their relative movement. This ensures smoother rotation of the swing arm 310, allowing the user to actuate the mechanism without resistance or a blocked sensation. In turn, this improves the overall user experience. Additionally, reducing friction between the operating member and the trigger portion helps limit component wear, thus extending the device's functional lifespan.

To further enhance stability during actuation, the contact surfaces between the operating member 320 and the trigger portion 316 may be configured with an arc-shaped profile. This design adaptation helps maintain a consistent and secure interface during relative movement, thereby contributing to the reliable and smooth operation of the comb's actuation mechanism.

Referring to FIG. 10, in some embodiments of the present invention, the operating member 320 comprises a pressing portion 324, a first column 322, and a second column 326. The first column 322 and the second column 326 are both disposed on the pressing portion 324 on the side facing the trigger portion 316 of the swing arm (310). The first column 322 is configured to abut directly against the trigger portion (316), enabling force transmission upon user interaction.

The trigger portion 316 is further provided with a third column 314. A first elastic member 330, such as a compression spring, is positioned such that one end is sleeved over the second column 326 and the other end is sleeved over the third column 314. This configuration ensures stable engagement and effective force transmission between the operating member and the trigger portion.

The pressing portion 324 is the user interface of the actuation system and is at least partially exposed outside the first comb body 100. It may be implemented in the form of a button, and its outer surface may include anti-slip features such as textured patterns or raised microstructures to enhance grip and usability.

During operation, when the user presses the pressing portion 324, the first column 322 exerts force on the trigger portion 316. This causes the swing arm 310 to rotate about the hinge shaft, driving the action portion 312 into contact with the second comb body 200. The applied force results in the disengagement of the second comb body 200 from the mounting groove 170. The first elastic member 330 helps maintain smooth rotational movement of the swing arm, reducing mechanical resistance and enhancing the user experience.

In this embodiment, the placement of the compression spring (i.e., the first elastic member 330) between the second column 326 and the third column 314 ensures that it remains stable during operation. As the operating member 320 and the trigger portion 316 move relative to each other, the spring may deflect off-axis, generating a restorative force that assists in returning the operating member 320 to its original position after release. This restoring effect is further supported by the action of the second elastic member 340, which helps reset the swing arm 310.

Referring to FIGS. 7 and 8, in some embodiments, the swing arm 310 comprises two structural segments: a straight segment and an arc segment. The action portion 312 is located on the straight segment, while the trigger portion 316 is located on the arc segment. These two segments are arranged along adjacent sides of the convex bulge 130 of the first comb body 100. The straight segment, being positioned away from the groove's notch, provides an optimal location for the push column 318 to exert force and dislodge the second comb body 200 from the mounting groove 170. Meanwhile, the arc segment positioned opposite the straight segment provides a convenient surface for integrating the trigger portion 316, ensuring effective alignment with the operating member 320.

In configurations where the first chamber 112 also houses internal electronics, such as a battery 410 and a circuit board 420, the layout is optimized for space efficiency. Specifically, the circuit board 420 and the arc segment of the swing arm are arranged on opposite sides of the convex bulge 130, while the battery 410 is positioned adjacent to the circuit board. This design approach ensures a compact and efficient use of internal space, improving both manufacturability and device performance.

Referring to FIGS. 3 to 7, in some embodiments of the present invention, the first comb body 100 comprises a first shell 110 and a first comb tooth assembly 120 connected thereto. The first shell 110 defines the first chamber 112, which serves as an installation space for internal components and functional mechanisms.

The first shell 110 is further provided with a second through hole 126, which creates a passage between the first chamber 112 and the external environment. This through-hole allows the comb teeth of the first comb tooth assembly 120 to extend outward and be partially exposed for user interaction.

The first comb tooth assembly 120 includes a base portion 124 and a plurality of comb teeth 122. The base portion 124 is positioned within the first chamber 112 and functions as a base structure to support the comb teeth 122, which are inserted through the second through hole 126. This configuration not only provides mechanical stability to the comb teeth but also ensures functional usability during combing.

The comb device also comprises a stimulation element 450, which may further include, but is not limited to, a phototherapy element 430 comprising one or more light-emitting diodes (LEDs) or a laser, a piezoelectric element, a magnetic element to provide magnetotherapy, a microcurrent element with low-voltage electrodes, a vibration motor, an ultrasonic wave therapy element, or a thermal treatment module capable of heating or cooling the skin-contact region and these stimulation element 450 can be disposed within the first chamber 112.

In an embodiment, the stimulation element 450 includes a phototherapy element 430 integrated within the first comb body and stacked against the side of the base portion 124 that is oriented away from the second through hole 126. Both the base portion 124 and the comb teeth 122 are formed from light-transmitting materials, thereby allowing light emitted by the phototherapy element 430 to pass through the comb structure and reach the scalp or hair during use. The phototherapy element includes a plurality of LEDs, lasers, or light sources, which provide multi-wavelength light therapy, capable of emitting different colours of therapeutic light, such as red, blue, green, yellow, and near-infrared. Each colour corresponds to a specific wavelength and serves a targeted dermatological or trichological purpose. For instance, red light (approximately 630-660 nm) penetrates deeply into the scalp to stimulate blood circulation and enhance hair follicle activity, thus promoting hair growth and repair. Blue light (around 415-470 nm) exhibits antibacterial properties and is effective in treating scalp acne and reducing inflammation. Green light (approximately 520-540 nm) can help reduce pigmentation and soothe sensitive or irritated scalp tissue. Yellow light (around 580-600 nm) improves oxygen exchange in the cells and aids in detoxifying the scalp, while near-infrared light (800-850 nm) reaches deeper layers to accelerate healing and reduce pain.

In an embodiment, the comb device may pre-condition the liquid medicament before it is dispensed through the outlet. This pre-conditioning may include heating or cooling the liquid, or subjecting it to light-based treatment, such as UV or near-infrared irradiation, to either sterilise the formulation or activate specific therapeutic ingredients. The liquid may pass through a light exposure chamber or pathway integrated within the second comb body, ensuring that it is properly treated before reaching the outlet. This process delivers a more consistent and enhanced therapeutic effect to the user during application.

In an embodiment, some of the comb teeth are fixed and constructed from metal or metal-like conductive materials to serve multifunctional purposes. These comb teeth, such as microcurrent electrodes 440, can deliver low-level electrical microcurrents, vibrations, and thermal stimulation, both heating and cooling, to the user's scalp. The integration of such teeth allows direct and efficient contact with the skin, enhancing therapeutic effectiveness. These metal-based comb teeth are internally connected to respective control modules housed within the comb body.

In an embodiment, the stimulation element 450 may be equipped with microcurrent therapy functionality, achieved through the integration of microcurrent electrodes 440 within the comb structure. The microcurrent electrodes 440 can be embedded along the surface of the first comb tooth assembly 120 to ensure effective skin or scalp contact during use. The microcurrent electrodes 440 are connected to a circuit board and a power source housed within the first chamber of the first comb body 100, enabling regulated emission of low-level electrical currents. The gentle microcurrents mimic the body's natural electrical signals, promoting cellular metabolism, enhancing ATP production, and improving blood flow in the scalp or skin area. For optimal conductivity, the microcurrent electrodes 440 can also be placed at the base of selected comb teeth. When the comb is drawn across the scalp, the micro-current electrodes 440 maintain intermittent or continuous contact, allowing the microcurrent to penetrate targeted regions for therapeutic benefit, such as hair follicle stimulation, reduced inflammation, and improved nutrient absorption.

In an embodiment, the comb device may include a vibration-generating element, such as a piezoelectric actuator or miniature vibration motor, that is integrated into the comb device to provide vibrational therapy to the user's scalp or skin. The vibration element may be housed within the first chamber 112 of the first comb body 100 or embedded near the base of the first comb tooth assembly 120 to ensure that the generated vibrations are transmitted directly through the comb teeth 122 during use. When activated, the piezoelectric element converts electrical energy into mechanical vibrations, which are then delivered through the comb teeth 122 to the scalp. These controlled micro-vibrations stimulate the underlying tissues, promoting increased blood circulation, relaxation of the scalp muscles, and enhanced delivery of nutrients to hair follicles. The placement of the vibration element is designed to allow even distribution of vibrational energy across the contact area, and it may operate in pulsed or continuous modes depending on user settings. The vibrational stimulation can aid in reducing scalp tension, encouraging hair regrowth, and providing a soothing massage-like effect during daily combing routines.

In an embodiment, the comb device incorporates a heating and cooling element, such as a Peltier module or semiconductor-based refrigeration component, to deliver targeted thermal stimulation, both heat and cold, to the user's scalp or skin. This element can be strategically embedded within the internal chamber of the first comb body and thermally linked to a heat-conductive plate or directly to the base of selected comb teeth 122 made from thermally conductive materials like metal alloys. The heat or cold generated is efficiently transferred through these comb teeth to the user's scalp, allowing precise delivery of warm or cool therapy. This setup enables benefits such as increased blood circulation, muscle relaxation, and pore opening via heat, or inflammation reduction and soothing of irritated skin via cold. The element is controlled by an integrated interface on the comb body, offering users the flexibility to toggle between thermal modes during grooming or treatment sessions.

In an embodiment, the comb device may further incorporate magnetic elements to provide magnetotherapy for the user's scalp or skin. These magnetic elements may be embedded within the first comb tooth assembly 120 or strategically placed along the base of the comb teeth 122, ensuring proximity to the scalp or skin during combing. Alternatively, magnetic strips or discs may be integrated into the inner wall of the comb body or at the root of the comb teeth in the second comb body. The magnetic elements may include permanent magnets or low-intensity therapeutic magnets selected for specific field strengths suitable for human use. When the comb is used, these elements create a local magnetic field that interacts with the user's scalp tissue, purportedly improving blood circulation, promoting hair follicle health, and supporting cellular repair mechanisms. The continuous contact and movement of the magnetic field across the skin during combing enhance the therapeutic exposure, delivering non-invasive, passive stimulation that may aid in reducing inflammation, relieving scalp tension, and encouraging healthier skin and hair growth.

The arrangement of the base portion 124 and the phototherapy element 430 is made around the convex bulge 130 of the first shell, ensuring optimal alignment and expanding the effective coverage area of the phototherapy function. This structural configuration enables the first comb body 100 to deliver targeted light therapy while maintaining efficient combing performance.

Referring to FIGS. 3 and 8, in certain embodiments of the present invention, the convex bulge 130 of the first comb body 100 is structurally reinforced to ensure durability during operation. Specifically, a positioning column 150 is integrally formed on the convex bulge 130, and a corresponding reinforcing column 160 is disposed on the first shell 110 at a location aligned with the positioning column 150. The reinforcing column 160 is configured to be sleeved over the positioning column 150, such that the outer surface of the positioning column is in direct contact with the inner surface of the reinforcing column.

This structural engagement between the positioning column 150 and the reinforcing column 160 provides dual benefits: (i) the positioning column ensures precise alignment of internal components, and (ii) the reinforcing column serves to support and stabilize the convex bulge 130. The reinforcing column 160 abuts against the convex bulge 130, thereby allowing it to partially absorb and distribute mechanical stress that may be exerted on the second comb body 200 during use.

Because the second comb body 200 is mounted within the mounting groove 170 formed by the convex bulge 130, any downward or lateral force applied to the second comb body is transmitted directly to the convex bulge. Without reinforcement, this could lead to deformation or structural fatigue over time. However, with the reinforcing column 160 in place, the load-bearing capacity of the convex bulge 130 is significantly enhanced, thereby ensuring long-term mechanical integrity and operational reliability of the comb device.

Referring to FIG. 2, in some embodiments of the present invention, the first comb body 100 includes a first comb tooth assembly 120. The second comb body 200 comprises a second housing 210 and a second comb tooth assembly 220, along with an operating member 320. Both the first comb tooth assembly 120 and second comb tooth assembly 220 are disposed on the same side of the first comb body 100, allowing for simultaneous engagement with the user's hair during combing. This arrangement supports coordinated functionality and ease of use.

The second housing 210 defines a second chamber 212, which serves as a reservoir for liquid substances such as medicinal fluids or hair treatment products. A liquid filling port is connected to this chamber and is sealed by a sealing cover 230. The sealing cover 230 may be detachably or movably connected to the second housing 210, allowing users to conveniently replenish the liquid when required. The filling port is positioned on the side opposite the comb teeth to avoid interference with the comb's operation and ensure smooth installation within the mounting groove 170.

At least part of the second comb tooth assembly 220 is hollow and in fluid communication with the second chamber 212, enabling controlled dispensing of liquid to the scalp or hair during combing. The liquid may be discharged through micropores, slits, or other outlet structures formed in the comb teeth. In some embodiments, as shown in FIG. 10, the second comb tooth assembly 220 includes a guide column with a rolling element 222 mounted at its end. The guide column is connected to the second chamber 212 and allows liquid flow only when inward pressure is applied. A spring mechanism biases the rolling element 222 to its default sealing position, preventing leakage when the device is not in use. The top of the guide column is positioned flush with or lower than the bottom surface of the second chamber to ensure complete liquid evacuation and prevent residue accumulation.

The operating member 320 is also positioned between the first and second comb tooth assemblies, on the same side as the combing surface. This placement minimizes the risk of accidental activation during use, particularly while the user is handling the comb.

The second comb body 200 may include one or more stimulation elements 450, such as medication dispensing, massage, light, heating, cooling, vibration, or microcurrent stimulation. In the present embodiment, the primary function of the second comb body is medicinal application, enabled by the internal liquid chamber and hollow comb teeth. During use, as the user combs through the hair, the medicinal liquid flows from the second chamber 212 through the comb teeth and onto the scalp or hair.

In addition, the first comb body 100 is further provided with a pair of charging electrodes, which may be disposed on an exterior surface of the comb body. The charging electrodes are configured to interface with an external charging dock, cable, or wireless charging base, thereby supplying electrical energy to recharge the internal battery. The placement of the charging electrodes ensures convenient alignment during charging while maintaining electrical isolation and user safety during operation.

The first comb body 100 may also be equipped with a battery indication light configured to provide a visual status of the battery. The battery indication light may be disposed on an external surface of the comb body in a location easily visible to the user. In one embodiment, the indication light may operate in multiple colour modes or flashing patterns to communicate different charging states, such as charging, fully charged, or low battery, allowing the user to monitor the power level of the device at a glance, thereby preventing unexpected interruption of scalp treatment sessions and ensuring timely recharging through the charging electrodes.

The first comb body 100 may also be equipped with one or more functional mechanisms, including but not limited to a massage mechanism, heating mechanism, phototherapy mechanism, and microcurrent mechanism. These may be integrated singularly or in combination. For example, in the embodiment shown in FIG. 3, the first comb body is provided with a phototherapy mechanism comprising a circuit board 420, a phototherapy element 430, and a battery 410. The first comb tooth assembly 120 is constructed of a light-transmitting material, allowing light emitted from the phototherapy element 430 to pass through the comb teeth and reach the user's scalp for therapeutic effect. A limiting column may be used to position and support the phototherapy element 430 within the first chamber 112.

Furthermore, the second comb body 200 may be connected with the first comb body 100 through electrical connectors, thereby establishing an electrical pathway between the two bodies. The arrangement enables electrical circuits and power from the first comb body 100 to be extended to the second comb body 200, allowing for the coordinated operation of functional mechanisms across both comb bodies. This multifunctional structure enables the comb device to simultaneously deliver medicinal fluids, therapeutic light, heat, massage, or microcurrents to the scalp, enhancing user convenience and scalp health outcomes.

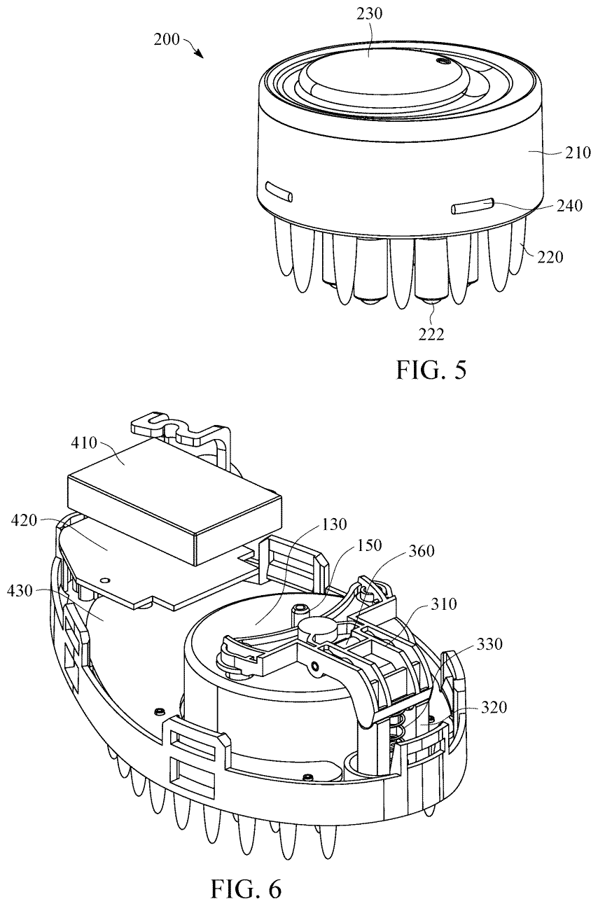

Referring to FIGS. 4 and 5, in an embodiment, a mechanical locking structure is employed to securely attach the second comb body (200) to the mounting groove 170 of the first comb body 100. Specifically, either the inner wall of the mounting groove 170 or the outer wall of the second comb body 200 is provided with a card slot 180, while the corresponding mating surface is provided with a buckle 240. These two elements are configured to interlock and form a snap-fit, latch-hook, slot-in, or magnetic connection between the first and second comb bodies.

In an embodiment, the card slot 180 is formed on the inner wall of the mounting groove 170, and the buckle 240 is provided on the outer surface of the second comb body 200. In an alternative configuration, the buckle 240 may be positioned on the inner wall of the mounting groove 170, while the card slot 180 is formed on the outer wall of the second comb body 200. Both configurations enable a secure and repeatable connection between the two comb bodies, while also allowing for quick detachment when needed.

Referring to FIGS. 12A and 12B, in one embodiment, a dual-push ejection system is provided. In a first state, a first press of the operating member 320 causes the second comb body 200 to move from a fully seated position within the mounting groove 170 to a partially ejected position, in which it protrudes from the first comb body 100. In this partially ejected state, the second comb body is intentionally positioned with a slight angular or positional offset relative to the first comb body. This offset enhances the mobility of the rolling element 222 over the user's scalp, thereby enabling smoother gliding and promoting the dispensing of medicament liquid during use. In a second state, a subsequent press of the operating member fully ejects the second comb body from the mounting groove, thereby providing access to the second chamber (liquid reservoir) within the second comb body for refilling or replacement.

In one embodiment, the comb device includes an alternate locking mechanism employing a spring pin 172 to securely retain the second comb body within the first comb body. The operating member 320 is provided with an annular ring 328 that maintains positional stability within the housing of the first comb body. A spring pin 172 is disposed adjacent to the annular ring 328 and housed within a wall of the mounting groove 170. In the resting state of the operating member, the positional relationship between the annular ring 328 and the spring biases the spring pin 172 forward toward the mounting groove.

The outer wall of the second comb body includes a slot 244 dimensioned to receive the advancing spring pin 172. When the second comb body is fully inserted into the mounting groove, the spring pin engages with the slot, thereby locking the second comb body in a fixed position relative to the first comb body. This engagement prevents unintentional detachment of the second comb body during normal use or handling, enhancing structural stability and user safety.

When the operating member 320 is pressed upward, interaction between the annular ring 328 and the spring assembly causes the spring pin 172 to retract from the slot 244, thereby disengaging the lock. Upon disengagement, the push column of the swing arm 310 advances, urging the second comb body outward from the mounting groove. This controlled release allows the user to remove or replace the second comb body with ease.

This interlocking and ejection mechanism enables the swing arm 310 to apply a separating force to the second comb body 200 in a smooth and reliable manner. When actuated, the swing arm pushes the second comb body outward, overcoming the engagement between the locking features, such as buckles, slots, guide protrusions, or grooves. The detachable connection facilitates convenient maintenance, modular replacement, and replenishment of consumables such as medicament liquid.

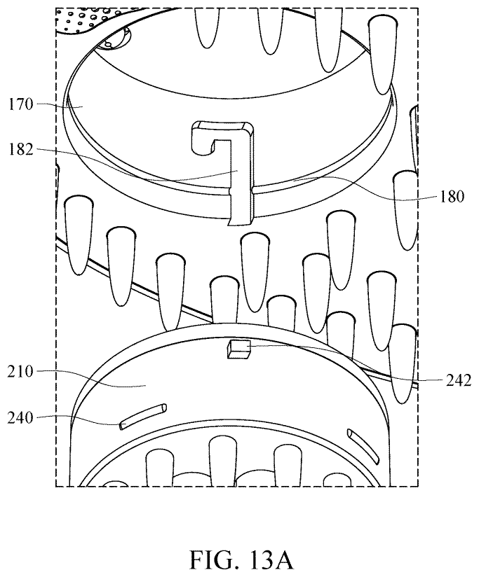

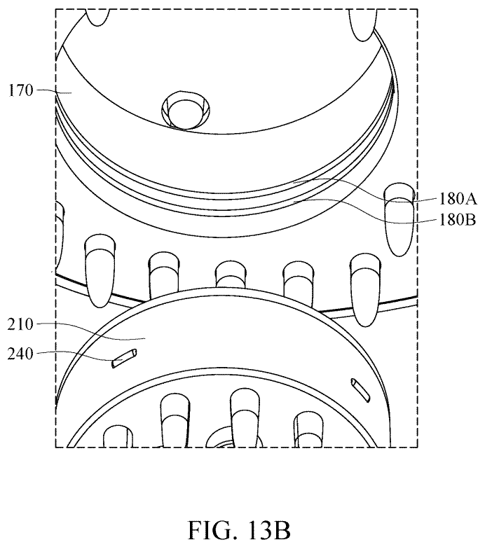

Referring to FIGS. 13A and 13B, in an embodiment, the comb device employs a dual-interface coupling arrangement between the first comb body 100 and the second comb body 200 to provide both precise alignment and controlled detachment.

As shown in FIG. 13A, the second comb body 200 is equipped with a precisely engineered guide protrusion 242 projecting from its outer wall, while the first comb body 100 includes a complementary guide groove 182 recessed along the inner surface of the mounting groove 170. During insertion, the guide protrusion 242 self-aligns with the guide groove 182, enabling the second comb body to slide smoothly and linearly into the mounting groove with minimal friction. This arrangement ensures stable seating, prevents rotational misalignment, and simplifies attachment and detachment during use or maintenance.

In an alternate or additional configuration, the guide groove 182 may be shaped in an L-configuration to form a rotation lock mechanism. In such cases, after axial insertion, a rotational movement, typically between 45° and 90°, is applied to cause the guide protrusion 242 to track along the bent portion of the L-shaped groove, thereby locking the second comb body into a fixed and non-removable position. This rotational engagement resists unintended detachment during combing operations, medicament dispensing, or vibration-assisted treatments.

As shown in FIG. 13B, the inner surface of the mounting groove 170 is further provided with dual ring surfaces, a first card slot 180A and a second card slot 180B, arranged in a stepped configuration. The outer wall of the second comb body 200 includes a buckle 240 dimensioned to interact sequentially with the two ring surfaces. When the second comb body is inserted, the buckle 240 initially engages the first card slot 180A. Upon a first press of the operating member, the buckle is displaced into engagement with the second card slot 180B, placing the second comb body in a partially released state in which it protrudes slightly from the mounting groove but remains partially retained for safe handling. On a second press of the operating member, the buckle 240 disengages completely from the second card slot 180B, allowing the second comb body to be fully ejected from the mounting groove 170.

This combined arrangement of guide alignment and sequential ring-surface engagement provides a secure, precise, and user-friendly connection between the comb bodies, enabling controlled assembly and disassembly, minimizing accidental release, and enhancing durability during repeated use.

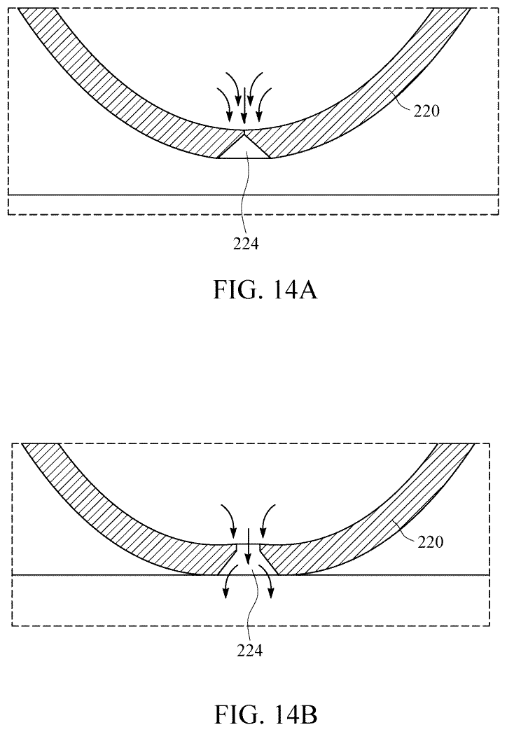

Referring to FIGS. 14A and 14B, in an embodiment, the second comb body 200 is provided with a plurality of hollow silicone second comb teeth, each integrally formed with a micro-orifice 224 located at its distal tip. These hollow comb teeth are in fluid communication with an internal second chamber configured to store therapeutic or medicinal liquids.

The silicone material of the second comb teeth provides inherent elasticity and resilience, enabling the micro-orifice 224 to remain normally closed when the comb is not in use. In this resting state, the orifice remains sealed, preventing unintended leakage of liquid and protecting the internal contents from contamination.

As shown in FIG. 14A, when the comb is pressed against the user's scalp during grooming or treatment, localized pressure is applied to the flexible silicone teeth, causing them to deform slightly. This deformation opens the micro-orifice 224, allowing a controlled flow of liquid from the second chamber directly to the user's scalp.

As illustrated in FIG. 14B, when the pressure is released, the elasticity of the silicone material returns the tooth to its original shape, causing the micro-orifice 224 to automatically close. This passive, pressure-sensitive dispensing mechanism eliminates the need for manual pumps or valves, ensuring precise, on-demand liquid release while maintaining hygiene and preventing waste.

In operation, the second comb body is configured to be partially ejected such that it remains positioned below the level of the first comb body. Upon pressing the comb against the scalp, the applied pressure causes the second comb body to move upward and align substantially flush with the first comb body. In this state, the micro-orifices formed in the silicone comb teeth transition to an open condition, thereby enabling dispensing of the liquid from the cosmetic container.

The passive dispensing mechanism of micro-orifice 224 offers several advantages, including improved hygiene, targeted delivery, and elimination of manual pumping or valving systems, simplifying the overall structure of the comb while ensuring efficient, on-demand release of therapeutic liquids. The integration of pressure-sensitive silicone micro-orifices 224 enhances user convenience and provides a seamless treatment experience without compromising on safety or cleanliness.

The comb device of the present invention offers a versatile and modular solution for integrated hair care, addressing multiple user needs such as phototherapy, scalp massage, liquid medicine application, heating, and microcurrent stimulation, all within a single compact device. By enabling easy detachment and replacement of functional comb bodies, the invention significantly improves user convenience, maintenance efficiency, and overall durability. Its ergonomic design and mechanical features, including a swing arm, operating member, and elastic restoring mechanisms, ensure reliable operation and enhance user experience. Given its adaptability, multifunctionality, and ease of customization, the invention holds substantial promise for application in the personal care and wellness industries, including at-home beauty treatments, professional salons, and therapeutic scalp care environments.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

1. A comb device comprising:
a first comb body including a first shell defining a first chamber and a mounting groove formed on a convex bulge extending from the first shell, the mounting groove being configured to detachably receive a second comb body;
a swing arm disposed within the first chamber and rotatably mounted to the first comb body via a hinge shaft, the swing arm comprising a trigger portion and an action portion;
an operating member movably connected to the first comb body, to allow user actuation, and configured to apply force to the trigger portion of the swing arm;
a push column extending from the action portion of the swing arm through a through-hole in the convex bulge, the push column being configured to engage the second comb body; and
wherein, upon user actuation of the operating member, the operating member applies force to the trigger portion, causing the swing arm to rotate about the hinge shaft such that the push column advances through the through-hole and pushes against the second comb body to disengage the second comb body from the mounting groove.

2. The comb device of claim 1, wherein the operating member comprises a pressing portion configured as a button exposed on an outer surface of the first comb body.

3. The comb device of claim 1, further comprising a biasing member configured to return the swing arm to its original position after actuation, wherein the biasing member comprises a first elastic member disposed between the operating member and the trigger portion of the swing arm.

4. The comb device of claim 3, wherein the biasing member comprises a second elastic member disposed between the action portion of the swing arm and an inner wall of the first chamber.

5. The comb device of claim 3, wherein the biasing member comprises a torsion spring sleeved around the hinge shaft and configured to bias the swing arm to its original position.

6. The comb device of claim 1, wherein the operating member comprises a first column configured to abut the trigger portion, a second column extending therefrom, and an annular ring for guided movement within the first comb body.

7. The comb device of claim 6, further comprising a first elastic member positioned between the second column of the operating member and a third column formed on the trigger portion of the swing arm.

8. The comb device of claim 1, wherein the first chamber further houses one or more stimulation elements selected from a phototherapy element, a microcurrent module, a vibration generator, or a thermal treatment element.

9. The comb device of claim 1, wherein the second comb body comprises hollow comb teeth with pressure-sensitive micro-orifices for controlled liquid dispensing upon scalp contact during or after partial ejection.

10. A comb device comprising:
a first comb body comprising a mounting groove;
a second comb body detachably mounted within the mounting groove of the first comb body;
an operating member configured to be pressed by a user;
an ejection mechanism comprising a swing arm having a push column, wherein the swing arm is configured in a manner that:
upon a first press of the operating member, the push column pushes the second comb body to protrude partially from the first comb body while remaining mechanically coupled; and
upon a second press of the operating member, detach the second comb body from the first comb body.

11. The comb device of claim 10, wherein the swing arm is configured such that the push column passes through a through hole formed in a convex bulge of the first comb body to engage a surface of the second comb body.

12. The comb device of claim 10, wherein in the first press, the push column pushes the second comb body to disengage a buckle on an outer surface of the second comb body from a first card slot provided on an inner surface of the mounting groove and to engage the buckle with a second card slot on the inner surface of the mounting groove.

13. The comb device of claim 10, wherein the partial protrusion of the second comb body after the first press provides an intentional misalignment between the first comb body and the second comb body to facilitate improved mobility of a rolling element on the second comb body during use.

14. The comb device of claim 12, wherein upon a second press, the buckle disengages from the second card slot, thereby detaching the second comb body from the mounting groove of the first comb body.

15. The comb device of claim 10, wherein the second comb body includes a guide protrusion and the mounting groove includes a guide groove, the guide protrusion being configured to align with the guide groove during insertion and detachment.

16. The comb device of claim 15, wherein the guide groove is L-shaped and configured to receive the guide protrusion via a linear insertion followed by rotational movement to lock the second comb body within the mounting groove.

17. The comb device of claim 10, wherein the partial protrusion of the second comb body in the first press is configured to allow therapeutic liquid stored within the second comb body to be more effectively dispensed through a rolling or pressure-activated outlet.

18. The comb device of claim 10, further comprising a spring pin attached to the operating member, and a slot in the second comb body to lock the second comb body in the mounting groove, wherein a first press of the operating member causes the spring pin to retract and release the second comb body for partial ejection.

19. A method for ejecting a second comb body from a first comb body of a comb device, the method comprising:
providing a mounting groove in the first comb body configured to removably receive the second comb body;
coupling a swing arm within the first comb body, the swing arm having a push column and being pivotable about a hinge shaft;
disposing an operating member adjacent to the swing arm, the operating member being actuatable by a user; and
ejecting the second comb body from the mounting groove to allow its removal, in response to a press of the operating member.

20. The method of claim 19, further comprising using a torsion spring or compression spring as an elastic member to return the swing arm to its default position after each actuation of the operating member.
